(19) United States
(12) Patent Application Publication
(10) Pub. No.: US 2014/0256601 A1
(43) Pub. Date: Sep. 11, 2014

(54) PREDISPERSED WAXES FOR OIL AND GAS DRILLING

(71) Applicant: H R D Corporation, Sugar Land, TX (US)

(72) Inventors: Abbas HASSAN, Sugar Land, TX (US); Aziz HASSAN, Sugar Land, TX (US); Gregory G. BORSINGER, Chatham, NJ (US)

(73) Assignee: H R D Corporation, Sugar Land, TX (US)

(21) Appl. No.: 14/200,444

(22) Filed: Mar. 7, 2014

Related U.S. Application Data
(60) Provisional application No. 61/775,022, filed on Mar. 8, 2013.

(51) Int. Cl. C09K 8/08; B01F 7/02; B01F 15/06; C09K 8/06

(52) U.S. Cl. CPC C09K 8/08; C09K 8/06; B01F 7/02; B01F 15/065; B01F 2015/062
USPC 507/103; 366/279; 366/148

(57) ABSTRACT

Herein disclosed is a method for producing a predispersed wax product comprising: operating a high shear device having at least one rotor/stator, configurable for a shear rate of at least 20,000 s⁻¹; introducing wax and a carrier liquid into said high shear device; and forming a dispersion of wax in a carrier liquid, wherein the wax comprises globules with an average diameter less than 5 mm.

### CROSS-REFERENCE TO RELATED APPLICATIONS

This application claims the benefit under 35 U.S.C. §119(e) of U.S. Provisional Patent Application No. 61/775,022 filed Mar. 8, 2013, the disclosure of which is hereby incorporated herein by reference.

### STATEMENT REGARDING FEDERALLY SPONSORED RESEARCH OR DEVELOPMENT

Not applicable.

### BACKGROUND

1. Technical Field

Embodiments of the present disclosure relate to systems and methods for dispersing fine particle waxes, specifically to using a high shear device to form dispersions with controlled particle size. More specifically, certain embodiments of the present disclosure relate to systems and methods for using a high shear device to prepare dispersions containing fine wax particles and other additives useful in the drilling and/or completion of oil and gas wells.

2. Background of the Disclosure

Various wellbore fluids are used in drilling and completion of oil and gas wells for a variety of purposes. Drilling fluids, or drilling muds, can be used to cool and lubricate the drilling assembly, remove cuttings from the wellbore, transmit hydraulic horsepower to downhole motors and tools, maintain wellbore stability, and control ingress of liquid and gas, i.e. formation fluids, into the wellbore. Drilling fluids are pressurized by pumps at the drilling rig and pumped down into the wellbore through the drill string. The drilling fluids pass through the drill bit and are returned back to the surface through the annulus between the outside of the drill pipe and the wellbore wall.

To control formation pressure, maintain wellbore stability, lubricate the drill bit, and provide other functions, drilling fluids often include suspended additives, including barites, clay, and other materials. For example, an oil-based drilling fluid may conventionally include an oil component (the continuous phase), a water component (the dispersed phase) and an organophilic clay, which are mixed together to form the drilling fluid. Emulsifiers, weighting agents, fluid loss additives, salts, organoclays, and numerous other additives may also be contained or dispersed into the drilling fluid.

Recent developments of deep well horizontal drilling techniques have exacerbated the need for providing lubrication of the drilling assembly due to increased friction from the drilling assembly contacting the wellbore wall. Further, as the sophistication of drilling fluids has increased, there is an increased need to reduce loss of drilling fluids (also referred to as seepage control) due to both environmental as well as economic considerations.

To enhance the lubrication without altering viscosity of the mud and reduce fluid loss, high melting waxes are used in micronized, coated or small particle form. The waxes are generally selected so at least a portion of the wax melts in high temperature environments, such as areas of high friction, and acts to lubricate and cool the contacting surfaces. Away from high temperature/high friction areas the wax material exists as solid particles. Fluid loss can be controlled by providing a wax having a particle size that conforms to the size of the fissure or orifice that needs to be blocked to prevent fluid loss. In certain examples, a desired particle size for minimizing fluid loss can range from 50 microns to about 5000 microns.

Waxes, both synthetic and naturally derived, are often used in micronized or fine powder form. Providing the desired particle size for the wax component has been by means of mechanical milling or jet milling. Often these processes require expensive cooling techniques such as cryogenic cooling to maintain temperatures below the melting point of the wax. To avoid melting of wax during milling, low temperature cryogenic gases are often employed to reduce processing temperatures thereby further increasing costs. Other techniques are also used to provide a fine-particle size wax in a liquid. Ball milling and pebble milling of waxes in a suitable solvent are often used to create a suspension of wax in solvent. These are also energy intensive techniques and require a suitable solvent (e.g. toluene, xylene) that may be undesirable for environmental and other reasons. The resulting wax is therefore expensive and there is a need for a better means of producing controlled wax particle size for lubricating and controlling fluid loss in drilling applications.

Thus, there is a need for systems and methods for preparing the direct conversion of wax into a dispersed form with a controlled particle size while minimizing energy consumption.

### SUMMARY

Herein disclosed is a method for producing a predispersed wax product comprising: operating a high shear device having at least one rotor/stator, configurable for a shear rate of at least 20,000 s⁻¹; introducing wax and a carrier liquid into said high shear device; and forming a dispersion of wax in a carrier liquid, wherein the wax comprises globules with an average diameter less than 5 mm.

In some embodiments, introducing the wax to the high shear device comprises raising the temperature of the wax. In some embodiments, the dispersion further comprises wax globules with a mean diameter of less than 1 mm. In some embodiments, the wax globules have a mean diameter of less than about 0.1 mm. In some embodiments, forming the dispersion further comprises cooling the wax globules and carrier liquid to below the melting temperature of the wax. In some embodiments, the dispersion comprises immiscible wax globules dispersed in the carrier liquid.

Herein also is disclosed a high shear system for the production of wax product, comprising; a high shear device that produces a dispersion of wax globules in carrier liquid, the dispersion having an average globule diameter of less than about 5 mm; and a storage vessel for storing a dispersion of wax particles in a carrier liquid.

In some embodiments, the high shear device comprises at least one rotor/stator set configured with gap clearance configured to form a dispersion having a predetermined globule diameter. In some embodiments, the rotor/stator set is configured to produce dispersed a shear rate of at least about 20,000 s⁻¹. In some embodiments, the dispersion comprises a carrier liquid with wax globules dispersed therein. In some embodiments, the method further comprises a heater configured for raising the temperature of the wax to above about the wax melting temperature prior to introduction to the high shear device. In some embodiments, the reactor comprises an inlet configured to reduce the temperature of the dispersion to below about the wax melting temperature. In some embodiments, the high shear device produces a dispersion having an average particle diameter of less than about 1 mm. In some embodiments, the wax globules have a mean diameter of less than about 0.1 mm.

Herein also disclosed is a method for producing a predispersed wax product comprising: operating a high shear device having at least one rotor/stator at a shear rate of at least 20,000 s⁻¹; introducing wax and a carrier liquid into said high shear device; and forming a dispersion of wax in a carrier liquid, wherein the wax comprises globules with an average diameter less than 5 mm.

In some embodiments, introducing the wax to the high shear device comprises raising the temperature of the wax. In some embodiments, the dispersion further comprises wax globules with a mean diameter of less than 1 mm. In some embodiments, the wax globules have a mean diameter of less than about 0.1 mm. In some embodiments, forming the dispersion further comprises cooling the wax globules and carrier liquid to below the melting temperature of the wax. In some embodiments, the dispersion comprises immiscible wax globules dispersed in the carrier liquid.

Thus, embodiments described herein comprise a combination of features and advantages intended to address various shortcomings associated with certain prior devices. The various characteristics described above, as well as other features, will be readily apparent to those skilled in the art upon reading the following detailed description of the preferred embodiments, and by referring to the accompanying drawings.

### BRIEF DESCRIPTION OF THE DRAWINGS

For a more detailed description of the preferred embodiment of the present invention, reference will now be made to the accompanying drawings, wherein:

FIG. 1 illustrates a schematic diagram of a system for the production of a wax dispersion; and

FIG. 2 is a cross-sectional diagram of a high shear device for the production of a wax dispersion in solvent.

### NOTATION AND NOMENCLATURE

As used herein, the term ‘dispersion’ refers to a liquefied mixture that contains at least two distinguishable substances (or ‘phases’). As used herein, a ‘dispersion’ comprises a ‘continuous’ phase (or ‘matrix’), which holds therein discontinuous droplets, bubbles, and/or particles of the other phase or substance. The term dispersion may thus refer to foams comprising gas bubbles suspended in a liquid continuous phase, emulsions in which droplets of a first liquid are dispersed throughout a continuous phase comprising a second liquid with which the first liquid is immiscible, and continuous liquid phases throughout which solid particles are distributed. As used herein, the term “dispersion” encompasses continuous liquid phases throughout which gas bubbles are distributed, continuous liquid phases throughout which solid particles are distributed, continuous phases of a first liquid throughout which droplets of a second liquid that is substantially insoluble in the continuous phase are distributed, and liquid phases throughout which any one or a combination of solid particles, immiscible liquid droplets, and gas bubbles is distributed. Hence, a dispersion can exist as a homogeneous mixture in some cases (e.g., liquid/liquid phase), or as a heterogeneous mixture (e.g., gas/liquid, solid/liquid, or gas/solid/liquid), depending on the nature of the materials selected for combination. A dispersion may comprise, for example, solid particles (e.g. solid wax) in a liquid (e.g. drilling fluid) and/or droplets of one fluid (e.g. melted wax) in a fluid with which it is immiscible.

Use of the phrase, ‘all or a portion of’ is used herein to mean ‘all or a percentage of the whole’ or ‘all or some components of.’

### DETAILED DESCRIPTION

Overview

The present disclosure provides a system and method for the dispersion of fine particulate waxes. The system and method employ a high shear mechanical device to provide rapid shearing of micron size particles in a controlled environment. Without being limited by theory, the high shear device is configured to form micron size particles of wax continuously for downstream applications. Further, a high shear device comprising rotor/stators in combination is used to disperse wax directly into a fluid medium.

Waxes in the present disclosure comprise any natural or synthetic wax, and in certain instances, any wax that is typified by a high degree of crystallinity and relatively sharp melting and solidification point. Natural waxes can be derived from palm, soybean, corn, castor, canola or other triglycerides. Synthetic waxes can be derived from ethylene and/or propylene with other comonomers such as vinyl acetate and maleic anhydride sometimes added to modify the final wax properties. Synthetic waxes generally range in molecular weight from about 500 to 20,000. For dispersing in polar fluids the waxes may have polar functionality by oxidation, maleation or copolymerization. Dispersing waxes in non polar compounds may be facilitated by using non polar or aliphatic waxes.

Chemical reactions involving liquids, gases, and solids rely on the laws of kinetics that involve time, temperature, and pressure to define the rate of reactions. Where it is desirable to react raw materials of different phases (e.g. solid and liquid; liquid and gas; solid, liquid and gas), one of the limiting factors controlling the rate of reaction is the contact time of the reactants.

In conventional reactors, contact time for the reactants, such as the wax and carrier liquid, is often controlled by mixing which provides contact between the reactants and/or phases. A reactor assembly that comprises a high shear device makes possible decreased mass transfer limitations and thereby allows the dispersion to approach the theoretical kinetic limitations more closely. When dispersion rates are accelerated, residence times may be decreased, thereby increasing obtainable throughput, efficiency, and product quality.

High shear devices (HSD) such as high shear mixers and high shear mills are generally divided into classes based upon their ability to mix fluids. Mixing is the process of reducing the size of inhomogeneous species or particles within the fluid. One metric for the degree or thoroughness of mixing is the energy density per unit volume that the mixing device generates to disrupt the fluid. The classes are distinguished based on delivered energy density. There are three classes of industrial mixers having sufficient energy density to create dispersions with particle or bubble sizes in the range of about 0 to about 50 μm consistently.

Homogenization valve systems are typically classified as high-energy devices. Fluid to be processed is pumped or injected under very high pressure through a narrow-gap valve into a lower pressure environment. The pressure gradients across the valve and the resulting turbulence and cavitations act to break-up and mildly shear any particles in the fluid. These valve systems are most commonly used in milk homogenization and may yield average particle size range from about 0.01 μm to about 1 μm. At the other end of the spectrum are fluid mixer systems classified as low energy devices. These systems usually have paddles or fluid rotors that turn at high speed in a reservoir of fluid to be processed, which in many of the more common applications is a food product. These systems are usually used when average particle, globule, or bubble, sizes of greater than 20 microns are acceptable in the processed fluid.

Between low energy, high shear mixers and homogenization valve systems, in terms of the mixing energy density delivered to the fluid, are colloid mills, which are classified as intermediate energy devices. The typical colloid mill configuration includes a conical or disk rotor that is separated from a complementary, liquid-cooled stator by a closely controlled rotor-stator gap, which may be in the range from about 0.25 μm to 10.0 mm. Rotors may be driven, for example, by an electric motor via direct drive, or alternatively, a belt mechanism. Many colloid mills, with proper adjustment, may achieve average particle, or bubble, sizes of about 0.01 μm to about 25 μm in the processed fluid. These capabilities render colloid mills appropriate for a variety of applications including, but not limited to: colloidal and oil/water-based dispersion processing. In certain instances, the colloid mills can be applied to processes such as preparation of cosmetics, mayonnaise, silicone/silver amalgam, roofing-tar mixtures, and certain paint products.

Description of System and Process for Creating Predispersed Waxes for Oil and Gas Drilling

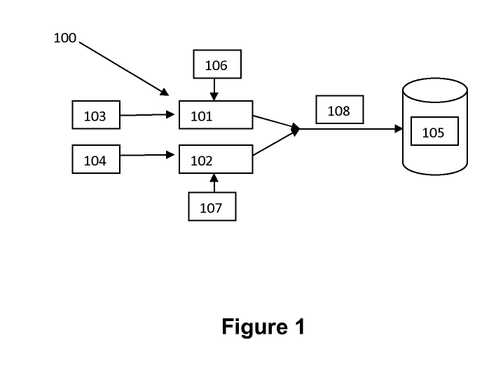

Referring now to FIG. 1, a system 100 for the creation of a predispersed wax includes wax supply 103 and 104, high shear devices 101 and 102, carrier liquid supply 106 and 107, and product storage 105. In general operation, wax from wax supplies 103, 104 is introduced to high shear devices 101, 102, respectively. In the high shear devices 101, 102, the wax is mixed with and dispersed within liquids from carrier liquid supplies 106, 107, respectively. The resulting dispersed wax 108 is placed in storage 105 for use or directly introduced into the drilling fluid at the wellhead.

Wax supplies 103, 104 may be a natural wax, synthetic wax, petroleum wax, or blends thereof. By way of example, suitable waxes include polyolefin waxes such as polyethylene and polypropylene waxes, microcrystalline wax, paraffin wax, montan wax, soy, castor canola, animal and palm wax or alpha olefin wax. Other waxes include Fischer-Tropsch waxes, carbonyl group-containing waxes, ester waxes, amide waxes, and fluorinated waxes. Carrier liquid supplies 106, 107 may include a liquid, such as water or hydrocarbon, acrylics and other additives including, but not limited to, emulsifiers, clays, dispersing agents, and thickeners, promoters, inorganic salts, ligno-cellulosic materials or combinations thereof.

High shear devices 101, 102 may be a mechanical shear device such as a homogenizer, acoustical shear, or rotor/stator to produce wax particles of the desired particle size for use in drilling fluid loss and lubrication applications at lower cost and more consistency. Common emulsification equipment could be an atmospheric-pressure homogenizer, a vacuum homogenizer, a high-pressure homogenizer, or ultrasonic emulsification equipment. Suppliers of mechanical emulsifiers include EGM of Mobile, Ala., Quadro Engineering of Ontario Canada, and IKA WORKS of Wilmington, N.C. Suppliers of acoustical emulsification equipment include Sonic Corp of Stratford, Conn. and Hielscher Ultrasonics GmbH Teltow, Germany. Although two shearing devices 101, 102 are shown, there may be additional units used in series or parallel as needed.

The dispersed wax 108 may have a particle size of the wax that is selected based on the intended application goal. There are a wide variety of applications for the dispersed wax of the present invention due to the flexibility of controlling particle size of the wax globules. Particle size can range from sub micron to micron size depending on the application need. Applications such as coatings, toners and inks usually require micron or sub micron size particles in either a waterbased, acrylic or organic solvent based vehicle. Personal care applications such as deodorant, mascara and facial creams can require a broad range of particle sizes from micron to mm size. Oil field down-hole applications such as fluid loss or lubrication generally require larger particles in the mm range. In general, the wax should be of a suitable size to not settle in the fluid medium (i.e. mud in down-hole applications). Settling rate will be a function of viscosity of the fluid medium as well as the size and density of the wax particle. The degree of agitation or flow of the fluid medium will also control settling rate of the wax particles. Further, the wax and additives may be selected so as to not impair the thixotropic nature of the drilling fluid. A drilling fluid is typically a thixotropic system meaning it exhibits low viscosity when sheared, such as on agitation or circulation, and thickens when such shearing action is halted.

Ideal wax particle size to perform the intended function in down-hole applications such as lubrication or fluid loss control will also vary. In fluid loss the desired wax particle size is dependent on the orifice size or porosity of the geology surrounding the well casing. Ideal wax particle size for lubricating applications will be a function of the size of the objects that need to be lubricated and the force between them. In both these applications the wax melting point should be above the local temperature to avoid wax melting. Drilling fluid typically reaches bottom hole temperatures of about 60° C. to 80° C.

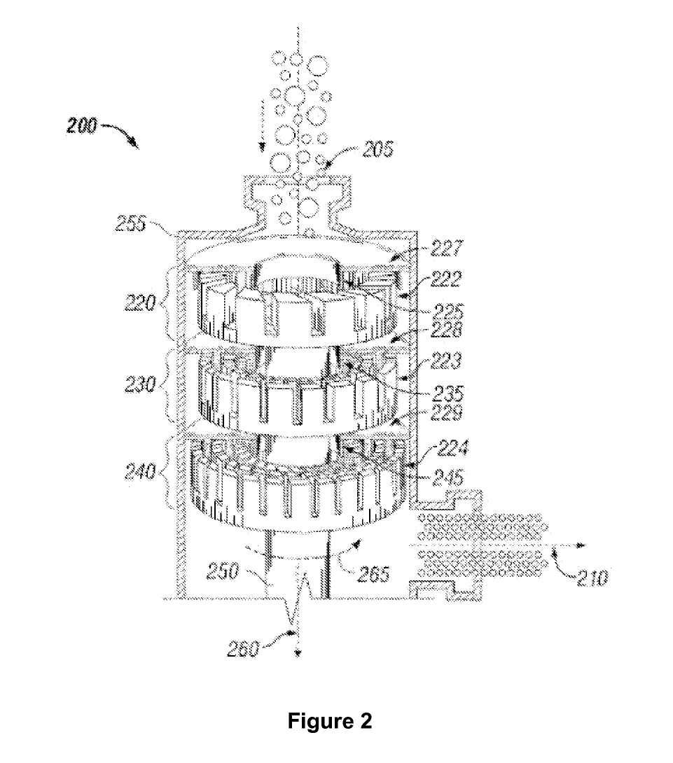

Referring now to FIG. 2, there is presented a schematic diagram of a high shear device 200. High shear device 200 comprises at least one rotor-stator combination. The rotor/stator combinations may also be known as generators 220, 230, 240 or stages without limitation. The high shear device 200 comprises at least two generators, and most preferably, the high shear device comprises at least three generators. The first generator 220 comprises rotor 222 and stator 227. The second generator 230 comprises rotor 223, and stator 228; the third generator comprises rotor 224 and stator 229. For each generator 220, 230, 240 the rotor is rotatably driven by input 250. The generators 220, 230, 240 are configured to rotate about axis 260, in rotational direction 265. Stator 227 is fixably coupled to the high shear device wall 255.

The generators include gaps between the rotor and the stator. The first generator 220 comprises a first gap 225; the second generator 230 comprises a second gap 235; and the third generator 240 comprises a third gap 245. The gaps 225, 235, 245 are between about 0.25 μm (10⁻⁶ in) and 10.0 mm (0.4 in) wide. Alternatively, the process comprises utilization of a high shear device 200 wherein the gaps 225, 235, 245 are between about 0.5 mm (0.02 in) and about 2.5 mm (0.1 in). In certain instances, the gap is maintained at about 1.5 mm (0.06 in). Alternatively, the gaps 225, 235, 245 are different between generators 220, 230, 240. In certain instances, the gap 225 for the first generator 220 is greater than about the gap 235 for the second generator 230, which is greater than about the gap 245 for the third generator 240.

Additionally, the width of the gaps 225, 235, 245 may comprise a coarse, medium, fine, and super-fine characterization. Rotors 222, 223, and 224 and stators 227, 228, and 229 may be toothed designs. Each generator may comprise two or more sets of rotor-stator teeth, as known in the art. Rotors 222, 223, and 224 may comprise a number of rotor teeth circumferentially spaced about the circumference of each rotor. Stators 227, 228, and 229 may comprise a number of stator teeth circumferentially spaced about the circumference of each stator. In embodiments, the inner diameter of the rotor is about 11.8 cm. In embodiments, the outer diameter of the stator is about 15.4 cm. In further embodiments, the rotor and stator may have an outer diameter of about 60 mm for the rotor, and about 64 mm for the stator. Alternatively, the rotor and stator may have alternate diameters in order to alter the tip speed and shear pressures. In certain embodiments, each of three stages is operated with a super-fine generator, comprising a gap of between about 0.025 mm and about 3 mm. When a feed stream 205 including solid particles is to be sent through high shear device 200, the appropriate gap width is first selected for an appropriate reduction in particle size and increase in particle surface area. In embodiments, this is beneficial for increasing catalyst surface area by shearing and dispersing the particles.

High shear device 200 is fed a reaction mixture comprising the feed stream 205. Feed stream 205 comprises a mixture or suspension of the dispersible phase and the continuous phase. The suspension comprises a liquefied mixture that contains two distinguishable substances (or phases) that will not readily mix and/or dissolve together. Without being limited by any particular theory, the suspensions have a continuous phase (or matrix), which holds therein discontinuous droplets, bubbles, and/or particles of the other phase or substance. The continuous phase may further comprise a solvent. The suspension may be highly viscous, such as slurries or pastes, with tiny particles of wax suspended in a liquid. As used herein, the term “suspension” encompasses a continuous phase comprising a carrier liquid with poorly mixed wax dispersions. In the case where the wax is to be further oxidized or grafted, gas bubbles, particles, droplets, globules, micelles, or combinations thereof, which are insoluble in the continuous phase carrier liquid, may also be present.

Feed stream 205 may include a particulate solid component. Feed stream 205 is pumped through the generators 220, 230, 240, such that product dispersion 210 is formed. In each generator, the rotors 222, 223, 224 rotate at high speed relative to the fixed stators 227, 228, 229. The rotation of the rotors forces fluid, such as the feed stream 205, between the outer surface of the rotor 222 and the inner surface of the stator 227 creating a localized high shear condition. The gaps 225, 235, 245 generate high shear forces that process the feed stream 205. The high shear forces between the rotor and stator function to process the feed stream 205 to create the product dispersion 210. Each generator 220, 230, 240 of the high shear device 200 has interchangeable rotor-stator combinations for producing a narrow distribution of the desired particle size, if feedstream 205 comprises a particle, or micelle size, in the product dispersion 210.

The product dispersion 210 of insoluble particles, liquid globules, or gas bubbles, in a liquid comprises a dispersion. In embodiments, the product dispersion 210 may comprise a dispersion of a previously immiscible or insoluble gas, liquid, or solid into the continuous phase. In an embodiment, the wax product dispersion 210 has an average particle, globule, or bubble, size less than about 5 mm; less than about 1 mm, or less than about 0.1 mm. In certain instances the average particle, globule, or bubble size may be micron or sub-micron in diameter. In certain instances, the average globule size is in the range from about 5 mm to about 1 mm. Alternatively, the average globule size is in the range from about (1 mm) to about (0.1 mm). In an embodiment, the wax product dispersion 210 has an average particle, globule, or bubble, size less than about 1.5 μm; in certain instances the globules are sub-micron in diameter. In certain instances, the average globule size is in the range from about 1.0 mm to about 0.1 μm. Alternatively, the average globule size is less than about 0.4 mm or less than about 0.1 mm.

Preferably, the globules are at least micron sized. The present disclosure configures the high shear device 200 to produce micron-size wax dispersions. In embodiments, the generators 220, 230, 240 are configured to produce wax dispersions with average particle, or globules sizes ranging from about 1 micron to about 5 mm in diameter. In certain embodiments, the globule size is about 50 microns in diameter. The globule sizes are selected such that they can be controlled by the amount of shear applied to the fluid and the configuration of the generators 220, 230, 240.

Tip speed is the velocity (m/sec) associated with the end of one or more revolving elements that is transmitting energy to the reactants. Tip speed, for a rotating element, is the circumferential distance traveled by the tip of the rotor per unit of time, and is generally defined by the equation V (m/sec)=π·D·n, where V is the tip speed, D is the diameter of the rotor, in meters, and n is the rotational speed of the rotor, in revolutions per second. Tip speed is thus a function of the rotor diameter and the rotation rate. In certain embodiments, altering the diameter or the rotational rate may increase the shear rate in high shear device 200.

For colloid mills, typical tip speeds are in excess of 23 m/sec (4500 ft/min) and may exceed 40 m/sec (7900 ft/min). For the purpose of the present disclosure the term ‘high shear’ refers to mechanical rotor-stator devices, such as mills or mixers, that are capable of tip speeds in excess of 1 m/sec (200 ft/min) and require an external mechanically driven power device to drive energy into the stream of products to be reacted. A high shear device combines high tip speeds with a very small shear gap to produce significant friction on the material being processed. Accordingly, a local pressure in the range of about 1000 MPa (about 145,000 psi) to about 1050 MPa (152,300 psi) and elevated temperatures at the tip are produced during operation. In certain embodiments, the local pressure is at least about 1034 MPa (about 150,000 psi). The local pressure further depends on the tip speed, fluid viscosity, and the rotor-stator gap during operation.

The shear rate is the tip speed divided by the shear gap width (minimal clearance between the rotor and stator). An approximation of energy input into the fluid (kW/l/min) may be made by measuring the motor energy (kW) and fluid output (l/min). In embodiments, the energy expenditure of a high shear device is greater than 1000 W/m³. In embodiments, the energy expenditure is in the range of from about 3000 W/m³ to about 7500 W/m³.

The high shear device 200 combines high tip speeds with a very small shear gap to produce significant shear on the material. The amount of shear is typically dependent on the viscosity of the fluid and the shear gap. The shear rate generated in a high shear device 200 may be greater than 20,000 s⁻¹. In embodiments, the shear rate generated is in the range of from 20,000 s⁻¹ to 100,000 s⁻¹. The shear rate generated in HSD 40 may be greater than 100,000 s−1. In some embodiments, the shear rate is at least 500,000 s⁻¹. In some embodiments, the shear rate is at least 1,000,000 s⁻¹. In some embodiments, the shear rate is at least 1,600,000 s⁻¹. In embodiments, the shear rate generated by HSD 40 is in the range of from 20,000 s⁻¹ to 100,000 s⁻¹. For example, in one application the rotor tip speed is about 40 m/s (7900 ft/min) and the shear gap width is 0.0254 mm (0.001 inch), producing a shear rate of 1,600,000 s⁻¹. In another application, the rotor tip speed is about 22.9 m/s (4500 ft/min) and the shear gap width is 0.0254 mm (0.001 inch), producing a shear rate of about 901,600 s⁻¹.

The rotor is set to rotate at a speed commensurate with the diameter of the rotor and the desired tip speed as described hereinabove. Transport resistance is reduced by incorporation of high shear device 200 such that the dispersion and reaction rate is increased by at least about 5%. Alternatively, the high shear device 200 comprises a high shear colloid mill that serves as an accelerated rate reactor. The accelerated rate reactor comprises a single stage, or dispersing chamber in certain instances. Further, accelerated rate reactor comprises a multiple stage, inline disperser comprising at least 2 stages.

Selection of the high shear device 200 is dependent on throughput requirements and desired particle or bubble size in the outlet dispersion 210. In certain instances, high shear device 200 comprises a Dispax Reactor® of IKA® Works, Inc. Wilmington, N.C. and APV North America, Inc. Wilmington, Mass. Model DR 2000/4, for example, comprises a belt drive, 4M generator, PTFE sealing ring, inlet flange 1″ sanitary clamp, outlet flange ¾″ sanitary clamp, 2 HP power, output speed of 7900 rpm, flow capacity (water) approximately 300 l/h to approximately 700 l/h (depending on generator), a tip speed of from 9.4 m/s to above about 41 m/s (about 1850 ft/min to above about 8070 ft/min). Several alternative models are available having various inlet/outlet connections, horsepower, tip speeds, output rpm, and flow rate. In further instances, the high shear device 200 comprises any device configurable to produce the high shear rate and throughput for forming a wax dispersion.

Without wishing to be limited to any particular theory, it is believed that the degree of high shear mixing in a high shear device is sufficient to increase rates of mass transfer. Further, a high shear device may produce localized non-ideal conditions that enable reactions to occur that would not otherwise be expected to occur based on Gibbs free energy predictions. Additionally, such reactions would not be expected at low shear mixing parameters. Localized non-ideal conditions are believed to occur within the high shear device resulting in increased temperatures and pressures with the most significant increase believed to be in localized pressures. The increase in pressures and temperatures within the high shear device are nearly instantaneous and highly localized. In certain instances, the temperature and pressure increases revert to bulk or average system conditions once exiting the high shear device. In some cases, the high shear-mixing device induces cavitation of sufficient intensity to dissociate one or more of the reactants into free radicals, which may intensify a chemical reaction or allow a reaction to take place at less stringent conditions than might otherwise be required. Cavitation may also increase rates of transport processes by producing local turbulence and liquid microcirculation (acoustic streaming) An overview of the application of cavitation phenomenon in chemical/physical processing applications is provided by Gogate et al., “Cavitation: A technology on the horizon,” Current Science 91 (No. 1): 35-46 (2006). The high shear-mixing device of certain embodiments of the present system and methods is operated under what are believed to be cavitation conditions that might be useful in reactions involving the oxidation of dispersed micronized wax or in such grafting reactions as maleation of wax using peroxide catalyst.

### EXAMPLE

Referring back to FIG. 1, system 100 is employed to create a finely dispersed wax in an aqueous solution. Wax supply 103 provides a supply of synthetic, hydrocarbon, or natural wax to high shear device 101. Carrier liquid supply 106 supplies a nonionic surfactant (Target HLB 11.0-12.0), potassium hydroxide (45%), and water to the high shear device 101. In certain embodiments, the materials that are supplied to the high shear reactor 101 include water and approximately 20 weight % wax, approximately 5 weight % nonionic surfactant, and approximately 0.01 weight % potassium hydroxide. In certain embodiments, the materials that are supplied to the high shear reactor 101 include water and approximately 30 weight % wax, approximately 5 weight % nonionic surfactant, and approximately 0.01 weight % potassium hydroxide. In certain embodiments, the materials that are supplied to the high shear reactor 101 include water and approximately 40 weight % wax, approximately 5 weight % nonionic surfactant, and approximately 0.01 weight % potassium hydroxide. Possible nonionic surfactants include Igepal CO-630 (Rhodia) or Tomadol 25-9 (Tomah).

In a first step water is supplied to the high shear device 101 and agitated for good movement without vortex. The water is heated to between 70-80° C. Once the water is heated the wax, nonionic surfactant, and potassium hydroxide are added to the high shear device 101. The mixture is then held at between 70 and 80° C. for 30 minutes. The agitation of the dispersion is maintained as the dispersion is cooled to approximately 50° C. The emulsion is discharged from the high shear reactor 101, which is set at 3000 psi (secondary 500/primary 2500). During the discharge from the high shear reactor 101 the emulsion temperature and viscosity will be increased.

Once discharged from the high shear device 101, the dispersion is cooled to approximately 30-35° C. by use of heat exchange or a secondary storage vessel (not shown). During cooling the viscosity of the dispersion will be reduced. The resultant cooled dispersion is moved to storage vessel 105 where it can be stored or be pumped into a wellbore.

While the preferred embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims that follow, that scope including all equivalents of the subject matter of the claims.

We claim:

1. A method for producing a predispersed wax product, comprising
operating a high shear device having at least one rotor/stator, configurable for a shear rate of at least 20,000 s⁻¹;
introducing wax and a carrier liquid into said high shear device; and
forming a dispersion of wax in a carrier liquid, wherein the wax comprises globules with an average diameter less than 5 mm.

2. The method of claim 1 wherein introducing the wax to the high shear device comprises raising the temperature of the wax.

3. The method of claim 1 wherein the dispersion further comprises wax globules with a mean diameter of less than 1 mm.

4. The method of claim 3 wherein the wax globules have a mean diameter of less than about 0.1 mm.

5. The method of claim 1 wherein forming the dispersion further comprises cooling the wax globules and carrier liquid to below the melting temperature of the wax.

6. The method of claim 5 wherein the dispersion comprises immiscible wax globules dispersed in the carrier liquid.

7. A high shear system for the production of wax product, comprising;
a high shear device that produces a dispersion of wax globules in carrier liquid, the dispersion having an average globule diameter of less than about 5 mm; and
a storage vessel for storing a dispersion of wax particles in a carrier liquid.

8. The system of claim 7 wherein the high shear device comprises at least one rotor/stator set configured with gap clearance configured to form a dispersion having a predetermined globule diameter.

9. The system of claim 8 wherein the rotor/stator set is configured to produce dispersed a shear rate of at least about 20,000 s⁻¹.

10. The system of claim 7 wherein the dispersion comprises a carrier liquid with wax globules dispersed therein.

11. The system of claim 7, further comprising a heater configured for raising the temperature of the wax to above about the wax melting temperature prior to introduction to the high shear device.

12. The system of claim 7, wherein the reactor comprises an inlet configured to reduce the temperature of the dispersion to below about the wax melting temperature.

13. The system of claim 7 wherein the high shear device produces a dispersion having an average particle diameter of less than about 1 mm.

14. The system of claim 7 wherein the high shear device produces a dispersion having an average particle diameter of less than about 0.1 mm.

15. A method for producing a predispersed wax product, comprising operating a high shear device having at least one rotor/stator at a shear rate of at least 20,000 s⁻¹;
introducing wax and a carrier liquid into said high shear device; and
forming a dispersion of wax in a carrier liquid, wherein the wax comprises globules with an average diameter less than 5 mm.

16. The method of claim 15 wherein introducing the wax to the high shear device comprises raising the temperature of the wax.

17. The method of claim 15 wherein the dispersion further comprises wax globules with a mean diameter of less than 1 mm.

18. The method of claim 17 wherein the wax globules have a mean diameter of less than about 0.1 mm.

19. The method of claim 15 wherein forming the dispersion further comprises cooling the wax globules and carrier liquid to below the melting temperature of the wax.

20. The method of claim 19 wherein the dispersion comprises immiscible wax globules dispersed in the carrier liquid.
